(19) United States
(12) Patent Application Publication
(10) Pub. No.: US 2010/0258538 A1
(43) Pub. Date: Oct. 14, 2010

(54) METHOD OF PRODUCING WELDED STRUCTURE AND METHOD OF PRODUCING BATTERY

(76) Inventors: Satoshi Suzuki, Aichi-ken (JP); Katsumi Ito, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/747,252

(22) PCT Filed: Dec. 9, 2008
(86) PCT No.: PCT/IB08/03386

§ 371 Date: Jun. 10, 2010

(30) Foreign Application Priority Data
Dec. 12, 2007 (JP) 2007-320772

(51) Int. Cl. B23K 15/00

(52) U.S. Cl. 219/121.14

(57) ABSTRACT

A case body (a first member) and a cap member (a second member) that have not been subjected to welding include a protrusion consisting of at least one of a first protrusion that protrudes from a first outer surface and a second protrusion that protrudes from a second outer surface when the case body and the cap member are assembled together such that the first outer surface is flush with the second outer surface. The protrusion is placed between the first outer surface and the second outer surface. In a condition where the first outer surface and second outer surface of the pre-welding case body and cap member are flush with each other, and the protrusion is placed between the first outer surface and the second outer surface, the protrusion is irradiated with a laser beam, so that the case body and the cap member are welded together with the protrusion providing a part of a weld. Thus, a method of producing a welded structure is provided for producing a welded structure in which the first member and the second member are firmly welded together.

### BACKGROUND OF THE INVENTION

1. Field of the Invention

The invention relates to a method of producing a welded structure, and a method of producing a battery.

2. Description of the Related Art

In recent years, various types of batteries have been proposed which are used as power supplies of portable equipment and cellular telephones, or used as power supplies of electric vehicles and hybrid cars. One type of the batteries has an electrode assembly, a case body in which the electrode assembly is housed, and a cap member that closes the opening of the case body, and the case body and the cap member are welded together (as disclosed in, for example, Japanese Patent Application Publication No. 2002-184365 (JP-A-2002-184365) and Japanese Patent Application Publication No. 11-77347 (JP-A-11-77347)).

Japanese Patent Application Publication No. 2002-184365 (JP-A-2002-184365) discloses a method of sealing an opening of a sealed-type battery having an electrode assembly, a battery case (case body) having a bottom at one end thereof and accommodating the electrode assembly therein, and a cap plate (cap member) that seals or closes the opening of the battery case. More specifically, the cap plate is fitted in an opening end of the battery case, and the cap plate and the battery case are positioned relative to each other such that the upper surface of the cap plate is flush with the opening end face of the battery case. In this condition, a tapered face of the battery case and a tapered face of the cap plate are opposed to each other, so as to form a welding groove having a V-shaped cross section, around the cap plate. Then, laser light is applied toward the welding groove, so as to join the battery case and the cap plate by laser welding. As a result, the battery case and the cap plate are joined to each other via a weld formed in the welding groove, and the opening of the battery case is sealed or tightly closed with the cap plate.

According to a laser welding method as disclosed in Japanese Patent Application Publication No. 11-77347 (JP-A-11-77347), one aluminum thin plate (that provides a case body) and the other aluminum thin plate (that provides a cap member) are positioned such that an outer surface of the above-indicated one aluminum thin plate is flush with an end face of the other aluminum thin plate, and laser light is applied to a joint of these aluminum thin plates so that the plates are welded together. More specifically, the joint of the aluminum thin plates is irradiated with the laser light, for welding of the thin plates, such that the thickness t of a portion of the thin plate (cap member) adjacent to the end face and the diameter d of a fused portion d satisfies the relationship of 0<t<d/2. In this manner, cracks are prevented from being formed when the fused portion solidifies and contracts.

In some cases, however, the case body (first member) and the cap member (second member) may not be firmly welded together by the methods as disclosed in JP-A-2002-184365 and JP-A-11-77347. Therefore, the resulting battery (welded structure) may not be sufficiently resistant to pressure, namely, may not achieve a sufficiently high withstand pressure. More specifically, if a large amount of weld slag is produced during welding, and a part of the metal that forms the cap member and the case body flies off or shatters, for example, the bead thickness is reduced by an amount corresponding to that of the flying metal, and the weld is recessed from the outer surface. Also, if a clearance is formed between the first member and the second member, prior to welding, the bead thickness is reduced by an amount of the fused metal that fills the clearance, and the weld is recessed from the outer surface. In these cases, a battery (welded structure) in which the case body (first member) and the cap member (second member) are sufficiently firmly welded together cannot be provided.

### SUMMARY OF THE INVENTION

The invention has been developed in view of the circumstances as described above, and provides a method capable of producing a welded structure in which a first member and a second member are firmly welded together, and a method capable of producing a battery in which a case body and a cap member are firmly welded together.

According to a first aspect of the invention, there is provided a method of producing a welded structure in which a first member made of a metal and having a first outer surface and a second member made of a metal and having a second outer surface are joined to each other, via a weld comprising a metal derived from the first member and the second member, such that the first outer surface is flush with the second outer surface, characterized by comprising the steps of: (a) preparing the first member and the second member which include a protrusion prior to welding, the protrusion comprising at least one of a first protrusion that protrudes from the first outer surface and a second protrusion that protrudes from the second outer surface when the first and second members are assembled together, prior to welding, such that the first outer surface is flush with the second outer surface, the protrusion being formed between the first outer surface and the second outer surface; and (b) assembling the first member and the second member together, prior to welding, such that the first outer surface is flush with the second outer surface, and irradiating the protrusion with an energy beam while the protrusion is placed between the first outer surface and the second outer surface, so as to weld the first member and the second member together such that the protrusion provides a part of the weld.

According to the method of producing the welded structure as described above, the first member and second member that have not been subjected to welding have the protrusion that consists of at least one of the first protrusion that protrudes from the first outer surface and the second protrusion that protrudes from the second outer surface when the first and second members are assembled together such that the first outer surface is flush with the second outer surface. With the protrusion thus positioned between the first outer surface and the second outer surface, the first member and the second member are welded together. More specifically, while the first and second members are assembled together such that the first outer surface is flush with the second outer surface, and the protrusion is placed between the first outer surface and the second outer surface, the protrusion is irradiated with an energy beam, so that the first member and the second member are welded together with the protrusion providing a part of the weld. According to the above method, the thickness of the weld bead can be made larger by an amount of metal that forms the protrusion, as compared with the conventional method by which first and second members having no protrusions are welded together. Consequently, the first member and the second member can be firmly welded and joined together.

For example, if a large amount of weld slag is produced during welding, and a part of the metal that forms the cap member and the case body flies off or shatters, the bead thickness is reduced by an amount corresponding to that of the flying metal, and the weld is recessed from the outer surface. According to the method of producing the welded structure as described above, the protrusion can make up for the amount of the metal that flies off as the weld slag (namely, a part of the metal that forms the protrusion flies off as a weld slag), and therefore, the bead thickness can be made larger than that achieved by the conventional method. Consequently, the welding strength is enhanced.

Also, if a clearance is formed between the first member and the second member during welding, the bead thickness is reduced by an amount of the fused metal that fills the clearance, and the weld is recessed from the outer surface. According to the method of producing the welded structure as described above, the metal that forms the protrusion can make up for the amount of metal that is reduced by filling the clearance, and therefore, the bead thickness can be made larger than that achieved by the conventional method. Consequently, the welding strength is enhanced. Thus, according to the method of production as described above, the welded structure in which the first member and the second member are firmly welded together can be produced.

In the method of producing the welded structure as described above, the protrusion preferably includes the first protrusion and the second protrusion.

In the method of producing the welded structure as described just above, the first member having the first protrusion that protrudes from the first outer surface and the second member having the second protrusion that protrudes from the second outer surface are used as pre-welding first and second members, and these first and second members are welded together. More specifically, the first member and the second member are assembled together such that the first outer surface is flush with the second outer surface, and the protrusion consisting of the first protrusion and the second protrusion is placed between the first outer surface and the second outer surface. In this condition, the protrusion is irradiated with an energy beam, and the first member and the second member are welded together such that the protrusion provides a part of the weld. In this manner, the weld bead is formed while being well balanced on the first member and the second member, so that the first member and the second member can be firmly welded together.

Also, the protrusion may consist solely of the first protrusion. Further, the protrusion may consist solely of the second protrusion.

In the method of producing the welded structure as described above, too, the metal that forms the protrusion makes up for the amount of metal that is reduced by filling the clearance during welding. Therefore, the bead thickness is prevented from being reduced, and is made larger than the bead thickness achieved by the conventional method, so that the first member and the second member can be firmly welded to each other.

According to another aspect of the invention, there is provided a method of producing a battery according to the method of producing a welded structure as described above, wherein: (a) the first member is a case body having a bottom at one end thereof and an opening at the other end thereof, the case body having an interior space that accommodates an electrode assembly having a positive-electrode plate, a negative-electrode plate, and a separator, (b) the second member is a cap member that closes the opening of the case body, the cap member having the second outer surface that is flush with the first outer surface of the case body when a peripheral portion of the cap member is laid on an opening end face of the case body and the opening of the case body is closed with the cap member, (c) the welded structure is a battery in which the electrode assembly is housed in the case body, and the opening of the case body is closed with the cap member, (d) the case body and the cap member that have not been subjected to welding include the protrusion comprising at least one of the first protrusion and the second protrusion when the opening of the case body is closed with the cap member, and (e) the case body and the cap member are welded together while the electrode assembly is housed in the case body and the opening of the case body is closed with the cap member.

According to the method of producing the battery as described above, the case body and the cap member have the protrusion consisting of at least one of the first protrusion that protrudes from the first outer surface of the case body and the second protrusion that protrudes from the second outer surface of the cap member when the opening of the case body is closed with the cap member. With the protrusion positioned between the first outer surface and the second outer surface, the case body and the cap member are welded together. More specifically, while the electrode assembly is housed in the interior of the case body, and the opening of the case body is closed with the cap member, the protrusion is irradiated with an energy beam, and the case body and the cap member are welded together such that the protrusion provides a part of the weld. Thus, the above-described method makes it possible to produce a battery in which the case body and the cap member are firmly welded together. Consequently, the battery (case) is prevented from being broken or damaged due to an increase in the pressure in the battery.

In this connection it is preferable that a cross-section of the protrusion taken in a direction perpendicular to a direction in which the opening end face of the case body extends is a rectangular cross-section. It is also preferable that a cross-section of the protrusion taken in a direction perpendicular to the direction in which the opening end face of the case body extends is a triangular cross-section.

In the method of producing the battery as described above, the first protrusion may be a surrounding first protrusion that extends along the opening end face of the case body, and the second protrusion may be a surrounding second protrusion that extends along the opening end face of the case body when the opening of the case body is closed with the cap member. In the pre-welding case body, the protrusion amount ratio X of the protrusion given by an equation (1) below satisfies the relationship of 0.05≦X≦0.5,

X=(S1+S2)/(B×C) (1)

where B is a thickness of a portion of an opening end portion of the case body that has not been subjected to welding, the opening end portion defining the opening, the portion excluding the first protrusion, S1 is a cross-sectional area of a first cross-section of the first protrusion taken in a direction perpendicular to a direction in which the opening end face extends, C is a thickness of a portion of the peripheral portion of the cap member that has not been subjected to welding, the peripheral portion being laid on the opening end face of the case body when the opening of the case body is closed with the cap member, the portion excluding the second protrusion, and S2 is a cross-sectional area of a second cross-section of the second protrusion taken in a direction perpendicular to the direction in which the opening end face extends.

If the first protrusion of the case body and the second protrusion of the cap member are too small, the weld bead may not have a sufficiently large thickness, and the case body and the cap member may not be sufficiently firmly welded together. On the contrary, if the first protrusion and the second protrusion are too big, it may be difficult to adequately fuse the opening end portion of the case body and the peripheral portion of the cap member, and the welding strength may be reduced.

According to the method of production as described above, the protrusion amount ratio X=(S1+S2)/(B+C) of the protrusion of the case body and cap member satisfies the relationship of 0.05≦X≦0.5. With the amount of the protrusion thus controlled, the case body and the cap member are welded to each other. Thus, the welding strength at a joint between the case body and the cap member is sure to be enhanced, as compared with the conventional method.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a perspective view of a battery according to first through fourth embodiments of the invention;

FIG. 2 is an enlarged, cross-sectional view of a weld formed between the case body and the cap member according to the first through fourth embodiments of the invention, which view corresponds to an enlarged view of a part of a section as seen in a direction of arrow A-A in FIG. 1;

FIG. 3 is a top view of the case body of the first embodiment;

FIG. 4 is a cross-sectional view of the case body of the first embodiment, which view corresponds to a cross-sectional view as seen in a direction of arrow B-B in FIG. 3;

FIG. 5 is a side view of the cap member of the first embodiment;

FIG. 6 is a top view of the cap member of the first embodiment;

FIG. 7 is a perspective view of the battery of the first embodiment before the case body and the cap member are welded together;

FIG. 8 is an enlarged cross-sectional view of a first protrusion of the case body and a second protrusion of the cap member according to the first embodiment, which view corresponds to an enlarged view of a part of a section as seen in a direction of arrow C-C in FIG. 7;

FIG. 9 is an explanatory view for explaining a welding step according to the first embodiment;

FIG. 10 is a table showing the results of pressure tests conducted on some examples of the invention and comparative examples;

FIG. 11 is an explanatory view for explaining a welding step according to a second embodiment of the invention;

FIG. 12 is an explanatory view for explaining a welding step according to a third embodiment of the invention;

FIG. 13 is an explanatory view for explaining a welding step according to a fourth embodiment of the invention;

FIG. 14 is a perspective view of a battery 400 according to a fifth embodiment of the invention;

FIG. 15 is an enlarged, cross-sectional view of a weld formed between a case body and a cap member according to the fifth embodiment of the invention, which view corresponds to an enlarged view of a part of a section as seen in a direction of arrow D-D in FIG. 14;

FIG. 16 is a perspective view of the battery of the fifth embodiment before the case body and the cap member are welded together; and

FIG. 17 is an enlarged, cross-sectional view of a first protrusion of the case body and a second protrusion of the cap member according to the fifth embodiment, which view corresponds to an enlarged view of a part of a section as seen in a direction of arrow E-E in FIG. 16.

### DETAILED DESCRIPTION OF EMBODIMENTS

Example embodiments of the present invention will be described in greater detail below with reference to the accompanying drawings.

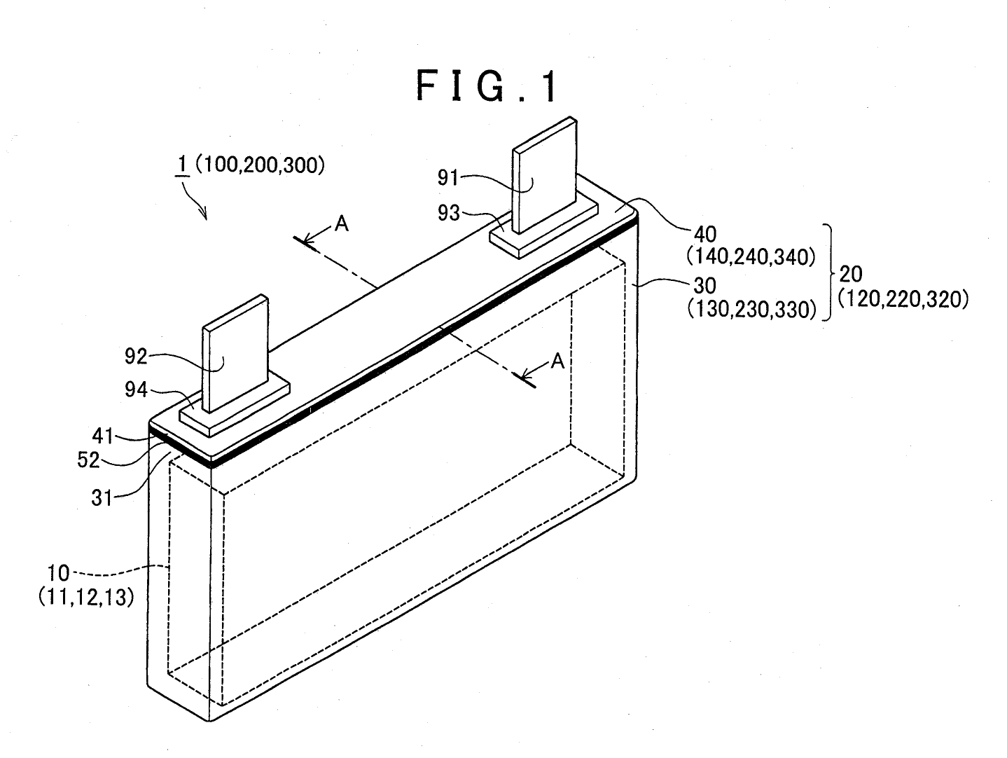

Referring to FIG. 1 through FIG. 17, first through fifth embodiments of the invention will be described. As shown in FIG. 1, a battery 1 of the first embodiment is a box-type, sealed lithium-ion secondary battery shaped like a rectangular parallelepiped. The battery 1 has an electrode assembly 10, a battery case 20 that houses the electrode assembly 10, a positive terminal 91, and a negative terminal 92. The battery 1 is used as, for example, a power supply for driving an electric vehicle or a hybrid car.

The electrode assembly 10 is a flat, rolled structure formed by rolling sheet-like positive-electrode plate 11, negative-electrode plate 12 and separator 13 together. The electrode assembly 10 includes a positive-electrode rolled section in which only a part of the positive-electrode plate 11 is folded into a roll, and a negative-electrode rolled section in which only a part of the negative-electrode plate 12 is folded into a roll. The positive-electrode rolled section is electrically connected to the positive terminal 91, and the negative-electrode rolled section is electrically connected to the negative terminal 92.

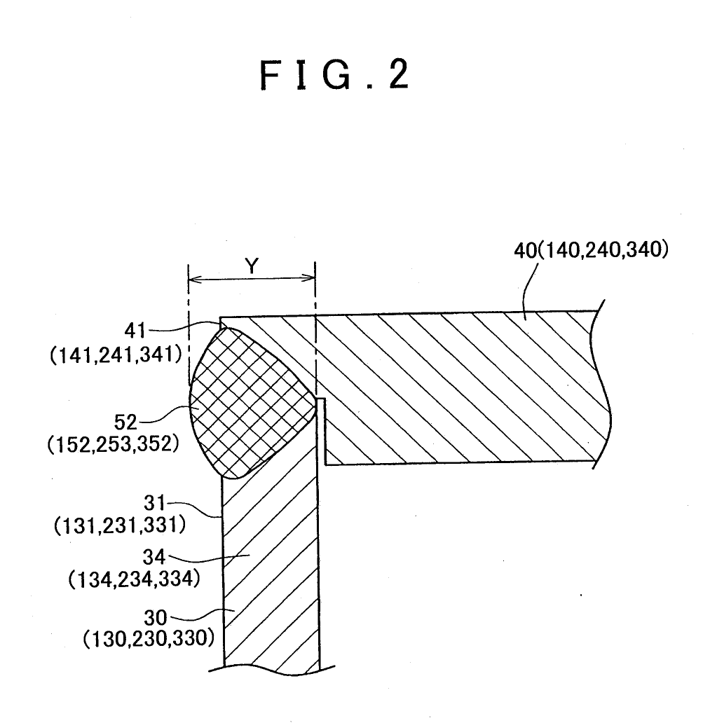

The battery case 20 has a case body 30 made of aluminum and a cap member 40 made of aluminum, which are assembled into an integral unit by welding. More specifically, as shown in FIG. 2, the case body 30 and the cap member 40 are joined to each other, via a weld 52 made of a metal (aluminum) derived from the case body 30 and the cap member 40, such that a first outer surface 31 (corresponding to each side face) of the case body 30 is flush with a second outer surface 41 (corresponding to each end face at the periphery) of the cap member 40.

In the first embodiment, in particular, the weld 52 protrudes from the first outer surface 31 of the case body 30 and the second outer surface 41 of the cap member 40, as shown in FIG. 2. Thus, the thickness Y of the weld bead is larger than the thickness of a side wall 34 of the case body 30 which includes the first outer surface 31. Therefore, the case body 30 and the cap member 40 are firmly welded together.

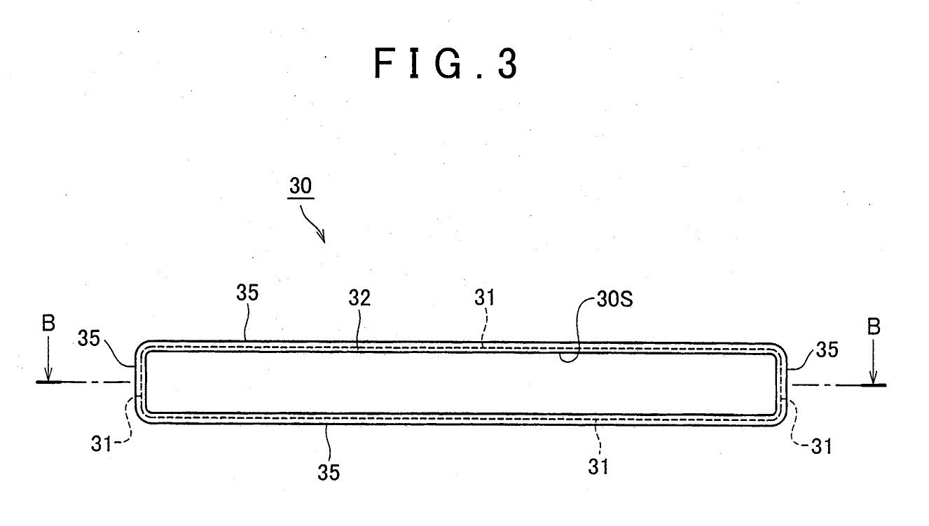

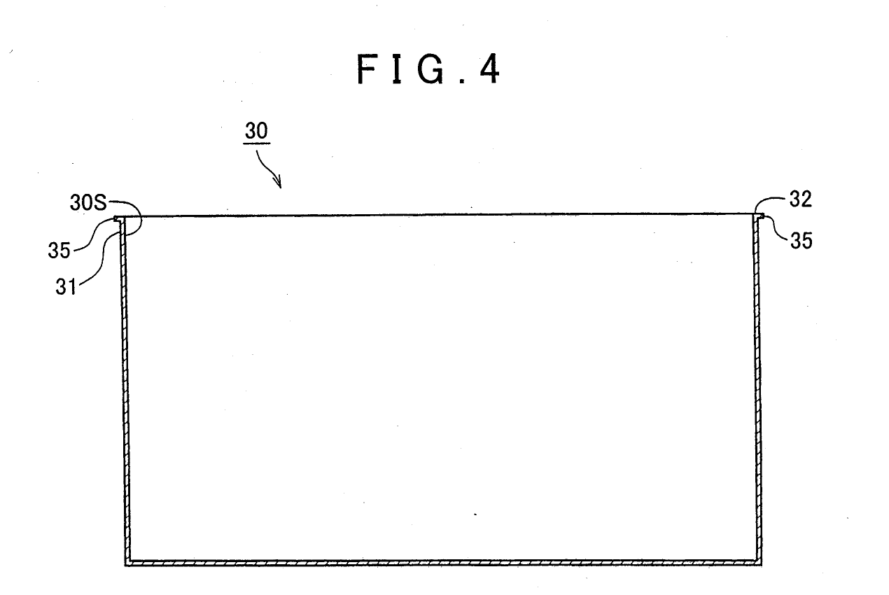

Next, a method of producing the battery according to the first embodiment of the invention will be explained. Initially, the case body 30 made of aluminum and the cap member 40 made of aluminum are prepared. As shown in FIG. 3 and FIG. 4, the case body 30 that has not been subjected to welding (which will be called “pre-welding case body 30”) has a generally rectangular, box-like shape having a bottom at one end thereof, and defines an opening 30S that allows the electrode assembly 10 to be housed in the case body 30. Furthermore, the case body 30 has a frame-like first protrusion 35 having a generally rectangular profile, which protrudes from the first outer surface 31 (corresponding to each side face) of the case body 30 and extends along opening end faces 32. The case body 30 may be fabricated by forming an aluminum plate by deep drawing, for example.

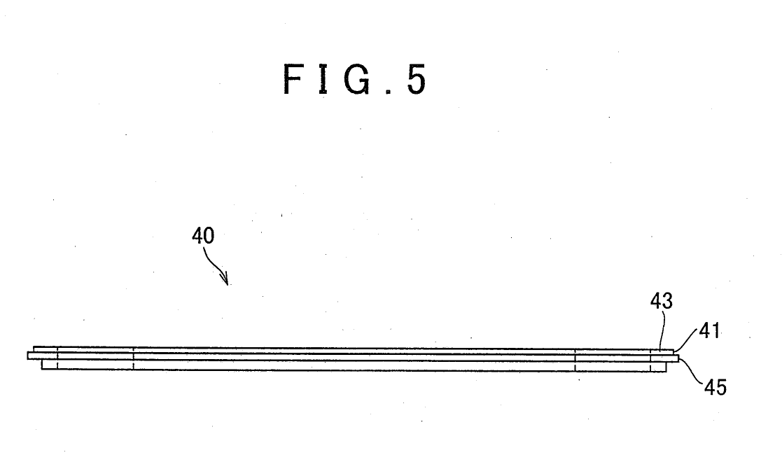

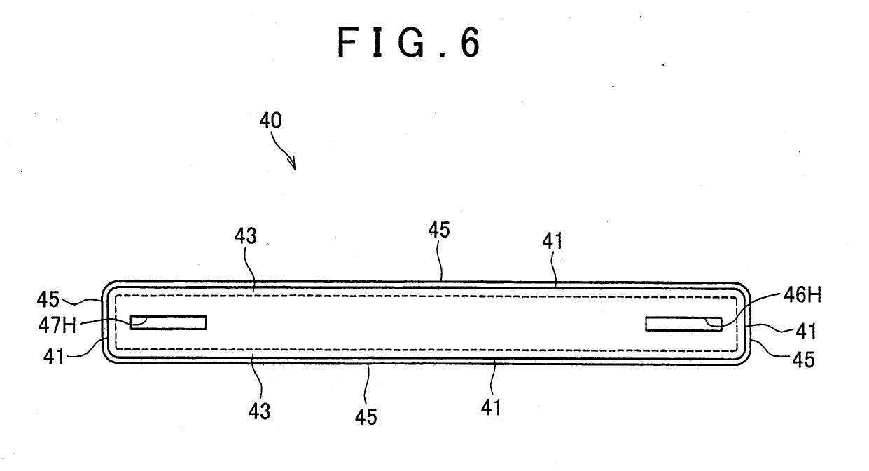

As shown in FIG. 5 and FIG. 6, the cap member 40 that has not been subjected to welding (which will be called “pre-welding cap member 40” is in the form of a generally rectangular plate, and has a positive-terminal insertion hole 46H through which the positive terminal 91 can be inserted, and a negative-terminal insertion hole 4711 through which the negative terminal 92 can be inserted. Furthermore, the cap member 40 has a frame-like second protrusion 45 having a generally rectangular profile, which protrudes from the second outer surface 41 (corresponding to each end face at the periphery) of the cap member 40 and extends over the entire periphery of the cap member 40. The cap member 40 may be fabricated by forming an aluminum plate by stamping, for example. In the first embodiment, the case body 30 corresponds to the first member, and the cap member 40 corresponds to the second member.

In the next step, the positive terminal 91 is welded to the positive-electrode rolled section of the positive-electrode plate 11 of the electrode assembly 10, and the negative terminal 92 is welded to the negative-electrode rolled section of the negative-electrode plate 12. Then, the positive terminal 91 is inserted through the positive-terminal insertion hole 46H of the cap member 40, and the negative terminal 92 is inserted through the negative-terminal insertion hole 47H. Thereafter, a positive-electrode sealing member 93 is mounted for providing a gastight seal between the positive terminal 91 and the positive-terminal insertion hole 46H, and a negative-electrode sealing member 94 is mounted for providing a gastight seal between the negative terminal 92 and the negative-terminal insertion hole 47H.

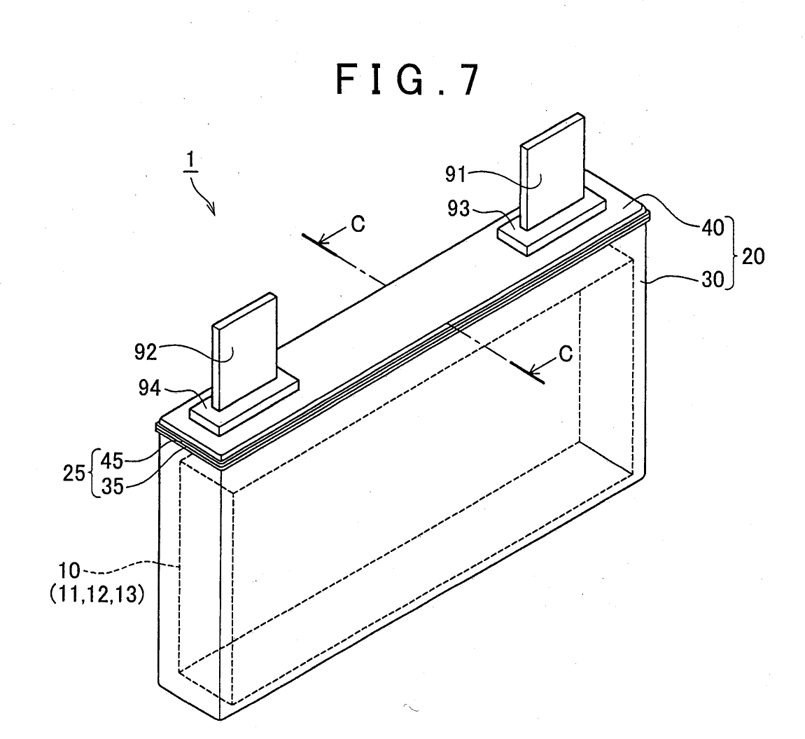

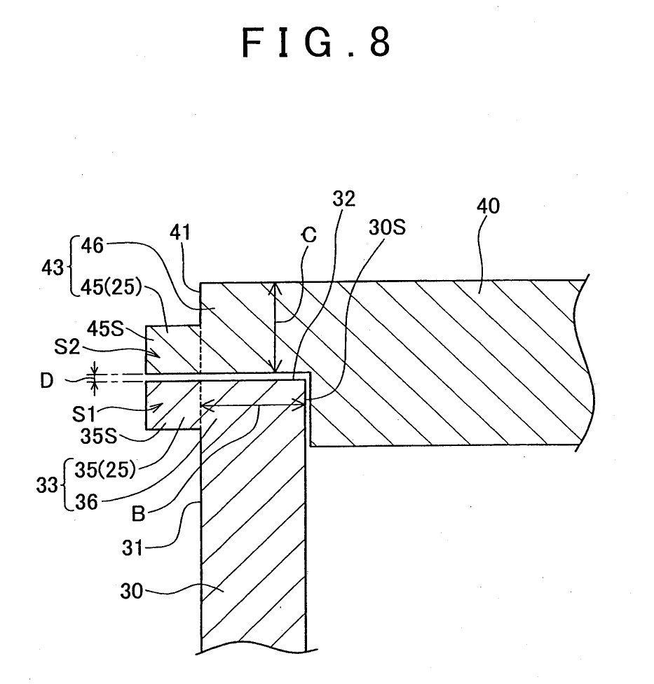

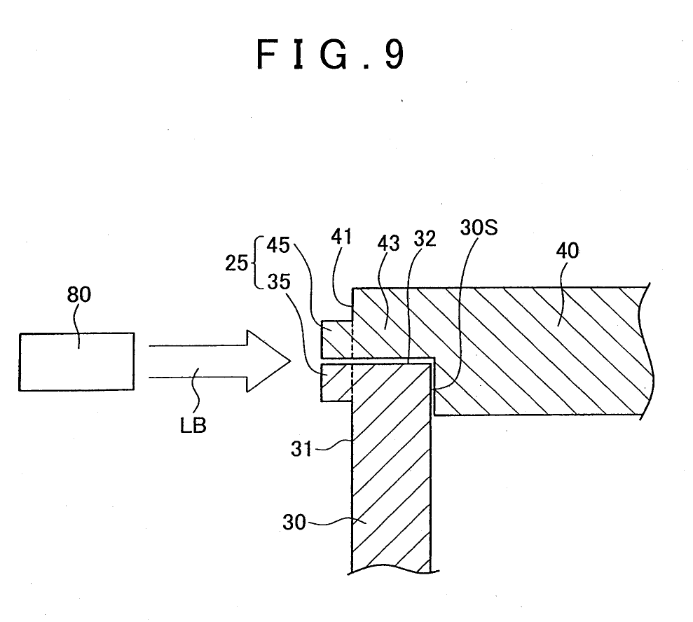

In the next step, as shown in FIG. 7, the electrode assembly 10 is placed in the interior of the case body 30, and the opening 30S of the case body 30 is closed with the cap member 40. More specifically, as shown in FIG. 8 and FIG. 9, a peripheral portion 43 of the cap member 40 is laid or placed on the opening end faces 32 of the case body 30, so that the opening 30S of the case body 30 is closed with the cap member 40. In this condition, the first outer surface 31 (corresponding to each side face) of the case body 30 is flush with the second outer surface 41 (corresponding to each end face at the periphery) of the cap member 40, and a protrusion 25 consisting of the first protrusion 35 and the second protrusion 45 is formed between the first outer surface 31 and the second outer surface 41.

In the pre-welding case body 30 as shown in FIG. 8, an opening end portion 33 that defines the opening 30S consists of the first protrusion 35 and a portion 36 having a thickness of B (mm), and a first cross-section 35S of the first protrusion 35 taken in a direction perpendicular to a direction in which the corresponding opening end face 32 extends has a cross-sectional area of S1 (mm²). Also in a condition where the opening 30S of the case body 30 is closed with the pre-welding cap member 40, the peripheral portion 43 of the cap member 40 which is laid or placed on the opening end faces 32 of the case body 30 consists of the second protrusion 45 and a portion 46 having a thickness of C (mm), and a second cross-section 45S of the second protrusion 45 taken in a direction perpendicular to the direction in which the corresponding opening end face 32 extends has a cross-sectional area of S2 (mm²).

In the above case, according to the first embodiment, the protrusion amount ratio X of the protrusion 25 given by Equation (1) below satisfies the relationship of 0.05≦X≦0.5. More specifically, where B=1.0, S1=0.15, C=1.0, and S2=0.15, X becomes equal to 0.30.

X=(S1+S2)/(B×C) (1)

In the next welding step, the case body 30 and the cap member 40 are welded together. More specifically, as shown in FIG. 9, while the opening 30S of the case body 30 is closed with the cap member 40 as described above, the protrusion 25 consisting of the first protrusion 35 and the second protrusion 45 is irradiated with a laser beam LB by means of a laser welding machine 80. The irradiation with the laser beam LB is performed over the entire periphery of the frame-like protrusion 25. In this manner, the case body 30 and the cap member 40 are welded together such that the protrusion 25 provides a part of the weld 52, as shown in FIG. 2.

In the first embodiment, the thickness Y of the weld 52 (weld bead) is 1.07 mm, which is larger than the thickness of the side wall 34 having the first outer surface 31 (which thickness is equal to the thickness B of the portion 36 of the opening end portion 33 which excludes the first protrusion 35, as shown in FIG. 8). Also, in the first embodiment, the case body 30 having the first protrusion 35 that protrudes from the first outer surface 31 is used as the pre-welding case body, while the cap member 40 having the second protrusion 45 that protrudes from the second outer surface 41 is used as the pre-welding cap member, and the case body 30 and the cap member 40 are welded together. As a result, the weld 52 (weld bead) is formed, while being well proportioned or balanced, on the case body 30 and the cap member 40, so that the case body 30 and the cap member 40 can be firmly welded together.

Subsequently, a specified amount of electrolytic solution is injected into the battery case 20, through an injection port (not shown). Thereafter, the injection port is sealed so that the battery 1 of the first embodiment is completed (see FIG. 1).

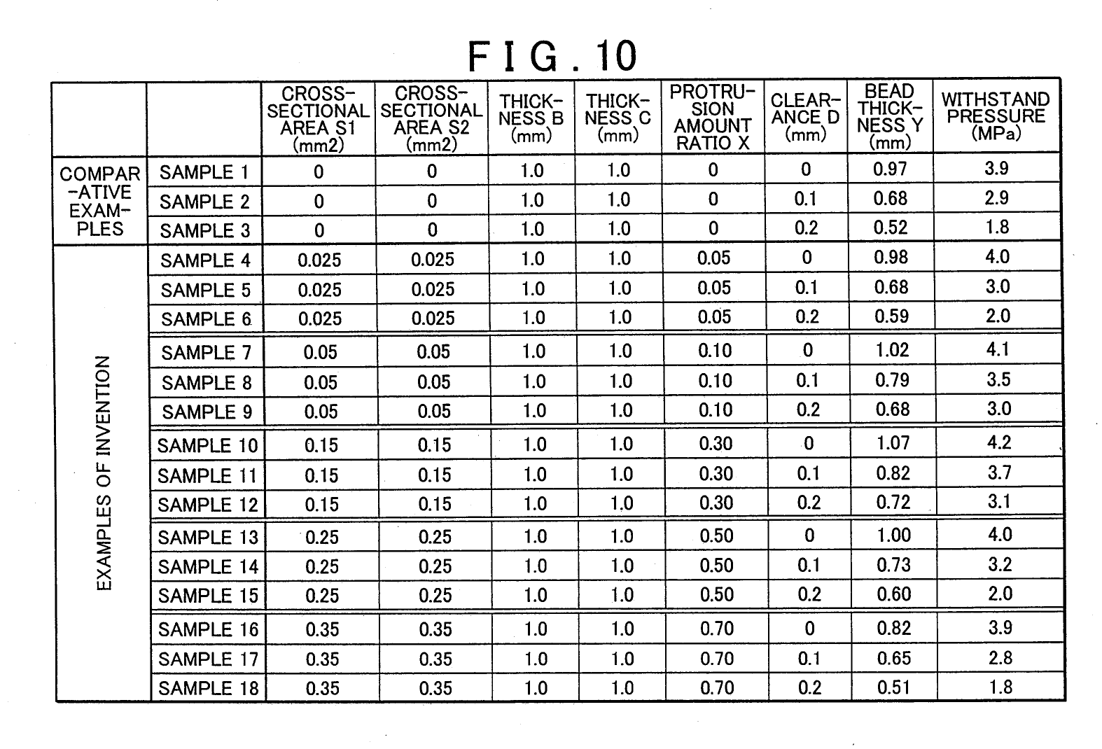

Next, a pressure test was conducted on the battery 1 produced in the manner as described above. More specifically, a minute through-hole was formed through the side wall 34 of the battery case 20, and oil was injected from the outside into the battery case 20 through the through-hole. In this manner, the internal pressure of the battery 1 was gradually increased, and the internal pressure (withstand pressure) of the battery 1 was measured when the battery case 20 was broken (specifically, when a crack appeared in the weld 52). The result of this test is shown in FIG. 10. In FIG. 10, Sample 10 corresponds to the battery 1 of the first embodiment.

Also, as shown in FIG. 10, seventeen types of batteries were prepared in each of which the value of the protrusion amount ratio X and/or the clearance D (see FIG. 8) between the case body 30 and the cap member 40 is/are different from those of the battery 1 (Sample 10) of the first embodiment. Pressure tests were conducted on these batteries in substantially the same manner as that conducted on the battery 1 of the first embodiment. The results of these tests are also shown in FIG. 10.

Samples 1-3 are batteries of Comparative Examples, each of which was fabricated by welding a case body having no first protrusion and a cap member having no second protrusion (case body and cap member having no protrusions) together. On the other hand, Samples 4-18 are batteries produced according to the present invention. Namely, each of the batteries of Samples 4-18 was fabricated by welding the case body 30 having the first protrusion 35 and the cap member 40 having the second protrusion 45 (the case body 30 and cap member 40 having the protrusion 25) together, in substantially the same manner as in the first embodiment as described above.

Some of the batteries (Samples 5, 8, 11, 14, 17) were produced with the clearance D being equal to 0.1 mm. Namely, a clearance of 0.1 mm was formed between the case body 30 and the cap member 40 when the pre-welding case body 30 was closed with the pre-welding cap member 40. In this condition, the case body 30 and the cap member 40 were laser-welded together to provide each of the above-indicated batteries. The same explanation applies to the batteries (Samples 6, 9, 12, 15, 18) which were produced with the clearance D being equal to 0.2 mm.

First, the test results regarding the batteries (Samples 1, 4, 7, 10, 13, 16) produced with the clearance D being equal to 0 mm are compared with one another). In Sample 1 (battery fabricated by welding case body and cap member having no protrusions), the pressure the battery could withstand or resist (which will be called “withstand pressure”) was 3.9 MPa. In Samples 4, 7, 10, 13 (batteries each fabricated by welding the case body and cap member having protrusions), the withstand pressures were 4.0 MPa, 4.1 MPa, 4.2 MPa, 4.0 MPa, respectively, all of which are greater than the withstand pressure of Sample 1. The batteries of Samples 4, 7, 10, 13 were produced with the protrusion amount ratio X being equal to 0.05, 0.10, 0.30, 0.50, respectively (see FIG. 10).

It may be said from the above results that the case body and the cap member can be more firmly welded together by the method of production of the battery (according to the present invention) in which the case body and cap member having protrusions are welded together, as compared with the method of production (conventional method) by which the case body and cap member having no protrusions are welded together. This is because, according to the method of production of this embodiment, the bead thickness Y of the weld 52 can be made larger by an amount of metal that forms the protrusion 25, than that achieved by the conventional method. In fact, the bead thickness Y was 0.97 mm in Sample 1, whereas the bead thicknesses Y of Samples 4, 7, 10, 13 were 0.98 mm, 1.02 mm, 1.07 mm, 1.00 mm, respectively, which are larger than that of Sample 1.

It is, however, to be noted that the battery of Sample 16 exhibited substantially the same withstand pressure (3.9 MPa) as the battery of Sample 1. Namely, the battery of Sample 16 and the battery of Sample 1 had substantially the same welding strength at the joint between the case body and the cap member. This may be because, in Sample 16, the value of the protrusion amount ratio X was as large as 0.70, namely, the volume of the protrusion 25 was too large, and therefore, the opening end portion 33 of the case body 30 and the peripheral portion 43 of the cap member 40 could not be adequately fused and welded together. As a result, the bead thickness Y of the weld 52 in the battery of Sample 16 was reduced to be smaller than that of the battery of Sample 1 (see FIG. 10).

Also, the test results regarding the batteries (Samples 2, 5, 8, 11, 14, 17) produced with the clearance D being equal to 0.1 mm are compared and analyzed. In Sample 2 (battery fabricated such that X=0), the withstand pressure was 2.9 MPa. In Samples 5, 8, 11, 14 (batteries fabricated such that 0.05≦X≦0.5), on the other hand, the withstand pressures were 3.0 MPa, 3.5 MPa, 3.7 MPa, 3.2 MPa, respectively, all of which are greater than the withstand pressure of Sample 2. In Sample 17 (battery fabricated such that X=0.7, however, the withstand pressure was 2.8 MPa, which is lower than the withstand pressure (2.9 MPa) of the battery of Sample 2.

Also, the test results regarding the batteries (Samples 3, 6, 9, 12, 15, 18) produced with the clearance D being equal to 0.2 mm are compared and analyzed. In Sample 3 (battery fabricated such that X=0), the withstand pressure was 1.8 MPa. In Samples 6, 9, 12, 15 (batteries fabricated such that 0.05≦X≦0.5), on the other hand, the withstand pressures were 2.0 MPa, 3.0 MPa, 3.1 MPa, 2.0 MPa, respectively, all of which are greater than the withstand pressure of Sample 3. However, the battery of Sample 18 (battery fabricated such that X=0.7 showed substantially the same withstand pressure (1.8 MPa) as the battery of Sample 3. As is understood from the above results, it is preferable that the battery is fabricated (the case body and the cap member are welded together) such that the protrusion amount ratio X satisfies the relationship of 0.05≦X≦0.5.

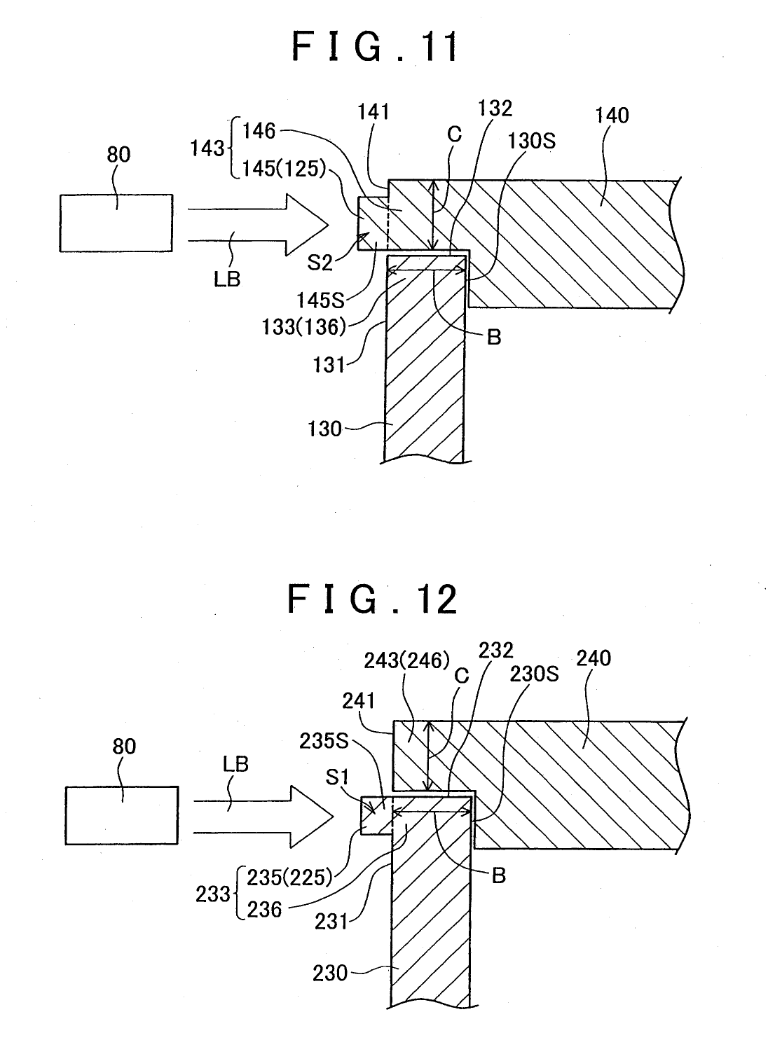

A second embodiment of the invention will be explained. As shown in FIG. 11, a battery 100 of the second embodiment is different from the battery 1 of the first embodiment only with respect to the battery case (the case body and the cap member), and is similar to the battery 1 in the other respects. More specifically, the battery 100 of the second embodiment is produced in substantially the same manner as that of the first embodiment, except for the use of a case body 130 and a cap member 140 as pre-welding case body and pre-welding cap member to be welded together. Thus, the method of producing the battery 100 of the second embodiment will be mainly explained herein.

Initially, the case body 130 made of aluminum and the cap member 140 made of aluminum are prepared. The pre-welding case body 130 is different from the case body 30 of the first embodiment in that the case body 130 has no first protrusion that protrudes from a first outer surface 131 (corresponding to each side face) of the case body 130 (see FIG. 11). On the other hand, the pre-welding cap member 140 has a generally rectangular, frame-like second protrusion 145 that protrudes from a second outer surface 141 (corresponding to each end face at the periphery) of the cap member 140 (see FIG. 11), like the cap member 40 of the first embodiment.

In the next step, the electrode assembly 10 is placed in the interior of the case body 130, and the opening 130S of the case body 130 is closed with the cap member 140. More specifically, as shown in FIG. 11, a peripheral portion 143 of the cap member 140 is laid or placed on opening end faces 132 of the case body 130, so that the opening 130S of the case body 130 is closed with the cap member 140. In this condition, the first outer surface 131 (corresponding to each side face) of the case body 130 is flush with the second outer surface 141 (corresponding to each end face at the periphery) of the cap member 140, and a protrusion 125 consisting of the second protrusion 145 is formed between the first outer surface 131 and the second outer surface 141.

In the second embodiment, too, the protrusion amount ratio X of the protrusion 125 given by Equation (1) below satisfies the relationship of 0.05×0.5, as in the first embodiment. In the second embodiment, however, S1 is equal to 0 in Equation (1). For example, where B=1.0, S1=0, C=1.0, and S2=0.20, X is equal to 0.20.

X=(S1+S2)/(B×C) (1)

In the following welding step, while the opening 130S of the case body 130 is closed with the cap member 140 as described above, the protrusion 125 consisting of the second protrusion 145 is irradiated with a laser beam LB emitted from the laser welding machine 80, as shown in FIG. 11. The irradiation with the laser beam LB is performed over the entire periphery of the frame-like protrusion 125. In this manner, the case body 130 and the cap member 140 are welded together such that the protrusion 125 provides a part of a weld 152, as shown in FIG. 2.

Subsequently, a specified amount of electrolytic solution is injected into the battery case 120, through an injection port (not shown). Thereafter, the injection port is sealed so that the battery 100 of the second embodiment is completed (see FIG. 1).

The battery 100 of the second embodiment produced in the above manner has the larger bead thickness Y of the weld 152 than those of the batteries of Samples 1-3 (Comparative Examples). Accordingly, the battery 100 of the second embodiment shows a higher welding strength at a joint between the case body and the cap member, and a higher withstand pressure, than the batteries of Samples 1-3 (Comparative Examples). From these results, it may be said that the case body and the cap member can be more firmly welded together according to the method of production of the second embodiment, as compared with the method (conventional method) by which the case body and cap member having no protrusions are welded together.

Next, a third embodiment of the invention will be explained. As shown in FIG. 12, a battery 200 of the third embodiment is different from the battery 1 of the first embodiment only with respect to the battery case (the case body and the cap member), and is similar to the battery 1 in the other respects. More specifically, the battery 200 of the third embodiment is produced in substantially the same manner as that of the first embodiment, except for the use of a case body 230 and a cap member 240 as pre-welding case body and pre-welding cap member to be welded together. Thus, the method of producing the battery 200 according to the third embodiment will be mainly explained herein.

Initially, the case body 230 made of aluminum and the cap member 240 made of aluminum are prepared. The pre-welding case body 230 has a generally rectangular, frame-like first protrusion 235 that protrudes from a first outer surface 231 (corresponding to each side face) of the case body 230 and extends over the entire periphery thereof (see FIG. 12), like the case body 30 of the first embodiment. On the other hand, the pre-welding cap member 240 has no second protrusion that protrudes from a second outer surface 241 (corresponding to each side face) of the cap member 240 (see FIG. 12), unlike the cap member 40 of the first embodiment.

In the next step, the electrode assembly 10 is placed in the interior of the case body 230, and the opening 230S of the case body 230 is closed with the cap member 240. More specifically, as shown in FIG. 12, a peripheral portion 243 of the cap member 240 is laid or placed on opening end faces 232 of the case body 230, so that the opening 230S of the case body 230 is closed with the cap member 240. In this condition, the first outer surface 231 (corresponding to each side face) of the case body 230 is flush with the second outer surface 241 (corresponding to each end face at the periphery) of the cap member 240, and a protrusion 225 consisting of the first protrusion 235 is formed between the first outer surface 231 and the second outer surface 241.

In the third embodiment, too, the protrusion amount ratio X of the protrusion 225 given by Equation (1) below satisfies the relationship of 0.05≦X≦0.5, as in the first embodiment. In the third embodiment, however, S2 is equal to 0 in Equation (1). For example, where B=1.0, S1=0.20, C=1.0, and S2=0, X is equal to 0.20.

X=(S1+S2)/(B×C) (1)

In the following welding step, while the opening 230S of the case body 230 is closed with the cap member 240 as described above, the protrusion 225 consisting of the first protrusion 235 is irradiated with a laser beam LB emitted from the laser welding machine 80, as shown in FIG. 12. The irradiation with the laser beam LB is performed over the entire periphery of the frame-like protrusion 225. In this manner, the case body 230 and the cap member 240 are welded together such that the protrusion 225 provides a part of a weld 252, as shown in FIG. 2.

Subsequently, a specified amount of electrolytic solution is injected into the battery case 220, through an injection port (not shown). Thereafter, the injection port is sealed so that the battery 200 of the third embodiment is completed (see FIG. 1).

The battery 200 of the third embodiment produced in the above manner has the larger bead thickness Y of the weld 252 than the batteries of Samples 1-3 (Comparative Examples). Accordingly, the battery 200 of the third embodiment shows a higher welding strength at a joint between the case body and the cap member, and a higher withstand pressure, than the batteries of Samples 1-3 (Comparative Examples). From these results, it may be said that the case body and the cap member can be more firmly welded together according to the method of production of the third embodiment, as compared with the method (conventional method) by which the case body and cap member having no protrusions are welded together.

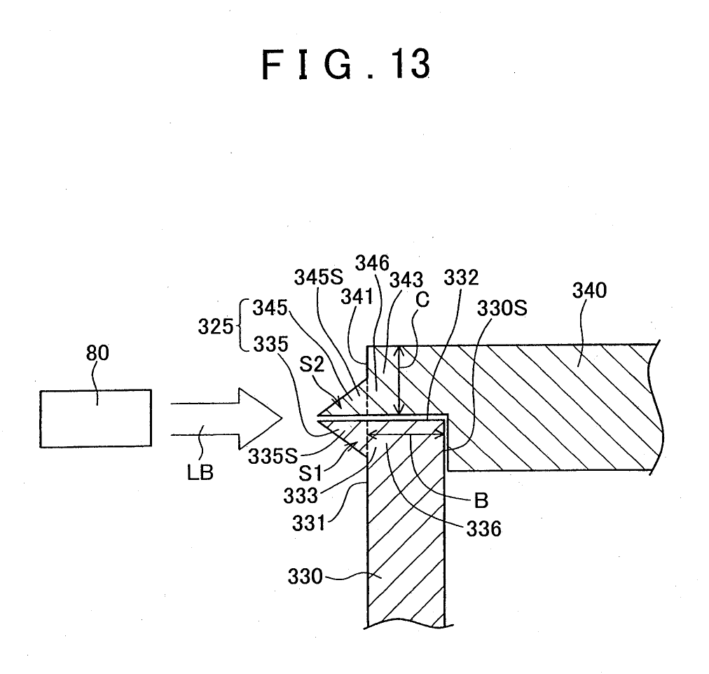

Next, a fourth embodiment of the invention will be explained. As shown in FIG. 13, a battery 300 of the fourth embodiment is different from the battery 1 of the first embodiment only with respect to the battery case (the case body and the cap member), and is similar to the battery 1 in the other respects. More specifically, the battery 300 of the fourth embodiment is produced in substantially the same manner as that of the first embodiment, except for the use of a case body 330 and a cap member 340 as pre-welding case body and pre-welding cap member to be welded together. Thus, the method of producing the battery 300 according to the fourth embodiment will be mainly explained herein.

Initially, the case body 330 made of aluminum and the cap member 340 made of aluminum are prepared. The pre-welding case body 330 has a frame-like first protrusion 335 that protrudes from a first outer surface 331 (corresponding to each side face) of the case body 330 and extends over the entire periphery thereof (see FIG. 13), like the case body 30 of the first embodiment. It is, however, to be noted that the first protrusion 335 has a different shape from that of the first protrusion 35 of the first embodiment. Specifically, a first cross-section 335S of the first protrusion 335 taken in a direction perpendicular to a direction in which the opening end face 332 extends assumes the shape of a triangle.

The pre-welding cap member 340 also has a frame-like second protrusion 345 that protrudes from a second outer surface 341 (corresponding to each end face at the periphery) of the cap member 340 and extends over the entire periphery thereof (see FIG. 13), like the case body 40 of the first embodiment. It is, however, to be noted that the second protrusion 345 has a different shape from that of the second protrusion 45 of the first embodiment. Specifically, a second cross-section 345S of the second protrusion 345 taken in a direction perpendicular to the direction in which the opening end face 332 extends assumes the shape of a triangle.

Then, the electrode assembly 10 is placed in the interior of the case body 330, and the opening 330S of the case body 330 is closed with the cap member 340. More specifically, as shown in FIG. 13, a peripheral portion 343 of the cap member 340 is laid or placed on opening end faces 332 of the case body 330, so that the opening 330S of the case body 330 is closed with the cap member 340. In this condition, the first outer surface 331 (corresponding to each side face) of the case body 330 is flush with the second outer surface 341 (corresponding to each end face at the periphery) of the cap member 340, and a protrusion 325 consisting of the first protrusion 335 and the second protrusion 345 is formed between the first outer surface 331 and the second outer surface 341.

In the fourth embodiment, too, the protrusion amount ratio X of the protrusion 325 given by Equation (1) below satisfies the relationship of 0.05≦X≦0.5, as in the first embodiment. For example, where B=1.0, S1=0.10, C=1.0, and S2=0.10, X is equal to 0.20.

X=(S1+S2)/(B×C) (1)

In the following welding step, while the opening 330S of the case body 330 is closed with the cap member 340 as described above, the protrusion 325 consisting of the first protrusion 335 and the second protrusion 345 is irradiated with a laser beam LB emitted from the laser welding machine 80, as shown in FIG. 13. The irradiation with the laser beam LB is performed over the entire periphery of the frame-like protrusion 325. In this manner, the case body 330 and the cap member 340 are welded together such that the protrusion 325 provides a part of a weld 352, as shown in FIG. 2.

Subsequently, a specified amount of electrolytic solution is injected into the battery case 320, through an injection port (not shown). Thereafter, the injection port is sealed so that the battery 300 of the fourth embodiment is completed (see FIG. 1).

The battery 300 of the fourth embodiment produced in the above manner has the larger bead thickness Y of the weld 352 than the batteries of Samples 1-3 (Comparative Examples). Accordingly, the battery 300 of the fourth embodiment shows a higher welding strength at a joint between the case body and the cap member, and a higher withstand pressure, than the batteries of Samples 1-3 (Comparative Examples). From these results, it may be said that the case body and the cap member can be more firmly welded together according to the method of production of the fourth embodiment, as compared with the method (conventional method) by which the case body and cap member having no protrusions are welded together.

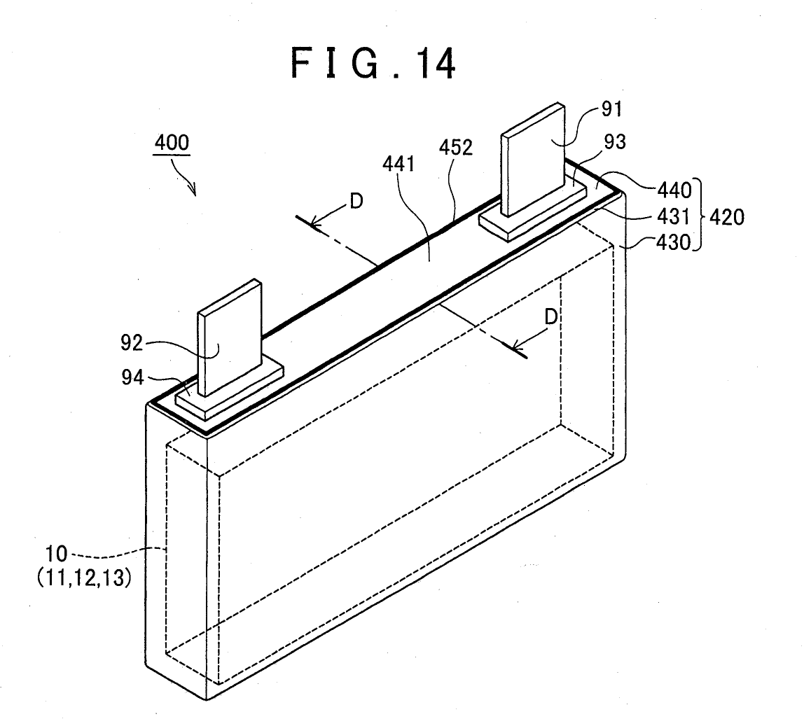

Next, a fifth embodiment of the invention will be explained. As shown in FIG. 14, a battery 400 of the fifth embodiment is different from the battery 1 of the first embodiment only with respect to the battery case (the case body and the cap member), and is similar to the battery 1 in the other respects. More specifically, the battery 400 of the fifth embodiment is produced in substantially the same manner as that of the first embodiment, except for the use of a case body 430 and a cap member 440 as pre-welding case body and pre-welding cap member to be welded together. Thus, the method of producing the battery 400 according to the fifth embodiment will be mainly explained herein.

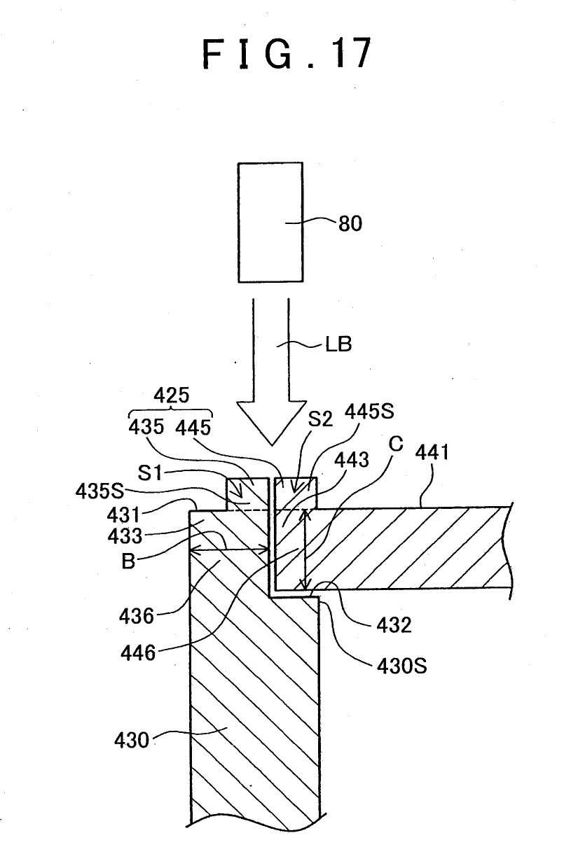

Initially, the case body 430 made of aluminum and the cap member 440 made of aluminum are prepared. The pre-welding case body 430 has a frame-like first protrusion 435 that protrudes from a first outer surface 431 (corresponding to each upper end face at the periphery) of the case body 330 and extends over the entire periphery thereof (see FIG. 17). The pre-welding cap member 440 has a frame-like second protrusion 445 that protrudes from a second outer surface 441 (corresponding to the upper surface) of the cap member 440 and extends over the entire periphery thereof (see FIG. 17). As is understood from a comparison between FIG. 17 and FIG. 9, the fifth embodiment is different from the first embodiment in the position of the first protrusion of the case body, the direction in which the first protrusion protrudes, the position of the second protrusion of the cap member, and the direction in which the second protrusion protrudes.

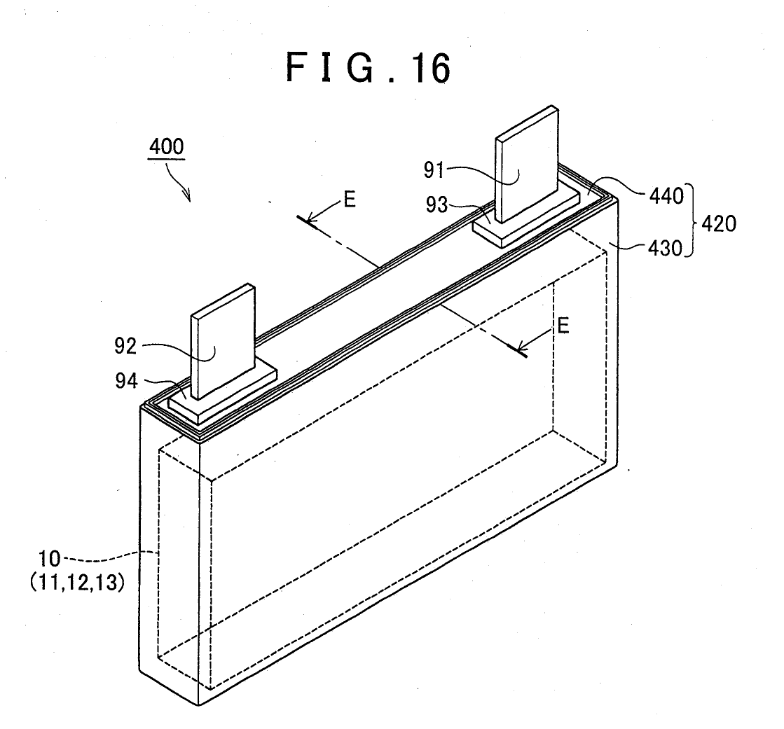

In the next step, as shown in FIG. 16, the electrode assembly 10 is placed in the interior of the case body 430, and the opening 430S of the case body 430 is closed with the cap member 440. More specifically, as shown in FIG. 17, a peripheral portion 443 of the cap member 440 is laid or placed on opening end faces 432 of the case body 430, so that the opening 430S of the case body 430 is closed with the cap member 440. In this condition, the first outer surface 431 (corresponding to each upper end face at the periphery) of the case body 430 is flush with the second outer surface 441 (corresponding to the upper surface) of the cap member 440, and a protrusion 425 consisting of the first protrusion 435 and the second protrusion 445 is formed between the first outer surface 431 and the second outer surface 441.

In the fifth embodiment, too, the protrusion amount ratio X of the protrusion 425 given by Equation (1) below satisfies the relationship of 0.05≦X≦0.5, as in the first embodiment. For example, where B=1.0, S1=0.10, C=1.0, and S2=0.10, X is equal to 0.20.

X=(S1+S2)/(B×C) (1)

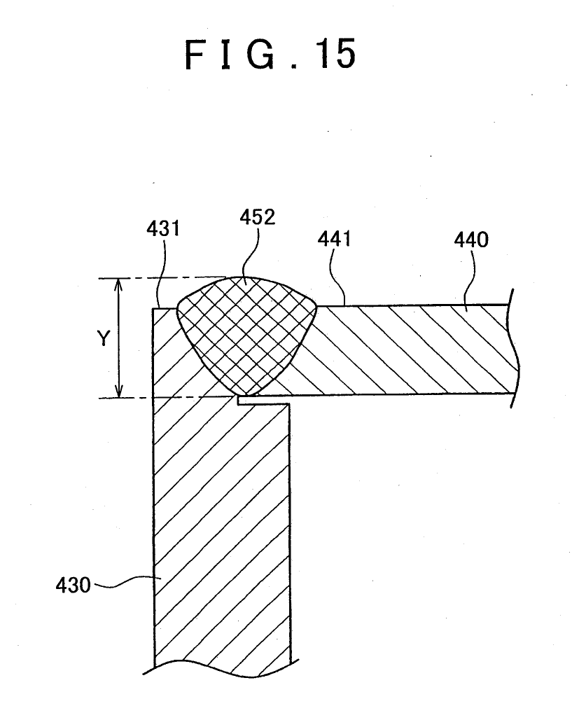

In the following welding step, while the opening 430S of the case body 430 is closed with the cap member 440 as described above, the protrusion 425 consisting of the first protrusion 435 and the second protrusion 445 is irradiated with a laser beam LB emitted from the laser welding machine 80, as shown in FIG. 17. The irradiation with the laser beam LB is performed over the entire periphery of the frame-like protrusion 425. In this manner, the case body 430 and the cap member 440 are welded together such that the protrusion 425 provides a part of a weld 452, as shown in FIG. 15.

Subsequently, a specified amount of electrolytic solution is injected into the battery case 420, through an injection port (not shown). Thereafter, the injection port is sealed so that the battery 400 of the fifth embodiment is completed (see FIG. 14).

The battery 400 of the fifth embodiment produced in the above manner has the larger bead thickness Y of the weld 452 than the batteries of Samples 1-3 (Comparative Examples). Accordingly, the battery 400 of the fifth embodiment shows a higher welding strength at a joint of the case body and the cap member, and a higher withstand pressure, than the batteries of Samples 1-3 (Comparative Examples). From these results, it may be said that the case body and the cap member can be more firmly welded together according to the method of production of the fifth embodiment, as compared with the method (conventional method) by which the case body and cap member having no protrusions are welded together.

While the present invention has been described above with reference to the first through fifth embodiments, it is to be understood that the invention is not limited to the above-described embodiments, but may be embodied with various changes or modifications as needed, without departing from the spirit and scope of the invention.

In the first through fifth embodiments, the first member (e.g., the case body 30) and the second member (e.g., the cap member 40) are welded together by laser welding. However, the method of welding the first member and the second member together is not limited to laser welding, but may be selected from other welding methods, such as electron beam welding, provided that an object to be welded is irradiated with an energy beam.

1. A method of producing a welded structure in which a first member made of a metal and having a first outer surface and a second member made of a metal and having a second outer surface are joined to each other, via a weld comprising a metal derived from the first member and the second member, such that the first outer surface is flush with the second outer surface, comprising:
preparing the first member and the second member which include a protrusion prior to welding, said protrusion comprising at least one of a first protrusion that protrudes from the first outer surface and a second protrusion that protrudes from the second outer surface when the first and second members are assembled together, prior to welding, such that the first outer surface is flush with the second outer surface, said protrusion being formed between the first outer surface and the second outer surface; and
assembling the first member and the second member together, prior to welding, such that the first outer surface is flush with the second outer surface, and irradiating the protrusion with an energy beam while the protrusion is placed between the first outer surface and the second outer surface, so as to weld the first member and the second member together such that the protrusion provides a part of the weld, wherein
the first member is a case of a battery and the second member is a cap member of the battery and the targets of welding are the first member and the second member.

2. The method of producing a welded structure according to claim 1, wherein the protrusion includes the first protrusion and the second protrusion.

3. The method of producing a welded structure according to claim 1, wherein the protrusion consists of the first protrusion.

4. The method of producing a welded structure according to claim 1, wherein the protrusion consists of the second protrusion.

5. The method of producing a welded structure according to claim 1, wherein a protrusion is provided on at least one of the first member and the second member, and the first member and second member are positioned so that the first member and second member are caught by the protrusion, and the first member and second member are welded thereon.

6. A method of producing a battery according to the method of producing a welded structure as defined in claim 1, wherein:
the first member is a case body having a bottom at one end thereof and an opening at the other end thereof, the case body having an interior space that accommodates an electrode assembly having a positive-electrode plate, a negative-electrode plate, and a separator;
the second member is a cap member that closes the opening of the case body, the cap member having the second outer surface that is flush with the first outer surface of the case body when a peripheral portion of the cap member is laid on an opening end face of the case body and the opening of the case body is closed with the cap member;
the welded structure is a battery in which the electrode assembly is housed in the case body, and the opening of the case body is closed with the cap member;
the case body and the cap member that have not been subjected to welding include the protrusion comprising at least one of the first protrusion and the second protrusion when the opening of the case body is closed with the cap member; and
the case body and the cap member are welded together while the electrode assembly is housed in the case body and the opening of the case body is closed with the cap member.

7. The method of producing a battery according to claim 6, wherein a cross-section of the protrusion taken in a direction perpendicular to a direction in which the opening end face of the case body extends is a rectangular cross-section.

8. The method of producing a battery according to claim 6, wherein a cross-section of the protrusion taken in a direction perpendicular to a direction in which the opening end face of the case body extends is a triangular cross-section.

9. The method of producing a battery according to claim 6, wherein:
the first protrusion is a surrounding first protrusion that extends along the opening end face of the case body;
the second protrusion is a surrounding second protrusion that extends along the opening end face of the case body when the opening of the case body is closed with the cap member;
a protrusion amount ratio X of the protrusion given by an equation (1) below satisfies the relationship of 0.05≦X≦0.5,
X=(S1+S2)/(B×C) (1)
where B is a thickness of a portion of an opening end portion of the case body that has not been subjected to welding, said opening end portion defining the opening, said portion excluding the first protrusion, and S1 is a cross-sectional area of a first cross-section of the first protrusion taken in a direction perpendicular to a direction in which the opening end face extends, and
where C is a thickness of a portion of the peripheral portion of the cap member that has not been subjected to welding, said peripheral portion being laid on the opening end face of the case body when the opening of the case body is closed with the cap member, said portion excluding the second protrusion, and S2 is a cross-sectional area of a second cross-section of the second protrusion taken in a direction perpendicular to the direction in which the opening end face extends.
